(19) United States
(12) Patent Application Publication
(10) Pub. No.: US 2023/0289967 A1
(43) Pub. Date: Sep. 14, 2023

(54) DEVICE FOR DIAGNOSING SPINE CONDITIONS

(71) Applicant: CAERUS MEDICAL, Loos (FR)

(72) Inventors: Naïm JALAL, Paris (FR); Eric Chevalier, Palaiseau (FR)

(73) Assignee: CAERUS MEDICAL, Loos (FR)

(21) Appl. No.: 17/692,605

(22) Filed: Mar. 11, 2022

(51) Int. Cl. G06T 7/00; G06T 7/62

(52) U.S. Cl. CPC G06T 7/0014; G06T 7/62; G06T 2207/30012; G06T 2207/20084

(57) ABSTRACT

A device for determining features of a subject's spine, including a processing unit having: a first module configured to receive a first set of spine image data of the subject, and to compute, based on spine image data of an examined spine, at least one first output relating to a first anatomical structure of the examined spine, at least one first output including a first feature of the examined spine; a second module configured to receive a first output of the first module and a second set of spine image data of the subject, and further configured to compute, based on spine image data of the examined spine and the first output, a second output relating to a second anatomical structure of the examined spine, and including a second feature of the examined spine.

### FIELD

The invention concerns a device for determining at least one feature of a subject's spine.

The invention also concerns a system including such a device, and a corresponding method for determining at least one feature of a subject's spine.

The invention relates to the field of medical images analysis, and more specifically analysis for identifying spine diseases.

### BACKGROUND

Low back pain constitutes one of the major causes of disability worldwide. Low back pain can be due to specific causes (such as tumors, infections or osteoporosis) or to non-specific causes.

Degenerative disc diseases are the most frequent underlying conditions associated with non-specific low back pain. For instance, it is estimated that the number of patients suffering from lumbar degenerative disc disease reaches 266 million each year worldwide.

Patients with persistent low back pain experience unnecessary extended pain, anxiety, and poor quality of life. Moreover, the economic burden associated to such conditions cannot be neglected: for instance, in the USA, the expenses associated to low back pain have gone from USD 26.3 billion dollars in 1998 to more than 100 billion dollars in 2011.

In clinical practice, magnetic resonance imaging (MRI) is the gold standard for diagnosing low back pain and particularly degenerative disc diseases. More precisely, several imaging sequences (such as, at least, sagittal T1w and T2w MRI, and axial T2w MRI) are used by a clinician to diagnose one or several conditions among a very wide range of conditions (discs and endplate degeneration, herniated disc, spondylolisthesis, laterolisthesis, stenosis of the central and lateral canal, vertebral collapse, etc.). This analysis requires both significant time and expertise of the spine that common radiologists do not have. As a consequence, the reliability of these diagnoses is moderate to barely substantial.

Therefore, it is crucial to provide a tool that allows for better early low back pain diagnosis in order to improve both patient outcome and economic and societal costs.

A platform has been recently developed, with the aim of offering diagnosis aid of spinal conditions based on MRI. More precisely, such platform is configured to segment acquired MRI images, and to output a diagnosis based on measurements performed on the computed segmented MRI images.

However, such platform is not satisfactory.

Indeed, resorting to MRI does not give access to reliable diagnosis of hypo/hyperlordosis, scoliosis and spondylolisthesis with the standard Meyerding scale. This is due to the fact that MRI images are acquired without load on the spine; in other words, during MRI, the spine is in a lengthened state. Consequently, the relevancy of such platform for detecting the aforementioned conditions is moot. Furthermore, such platform is unable to detect several conditions, for example disc degeneration, plateaus degeneration, Schmorl nodes, vertebral compression or even facet arthritis, so that a clinician can only partially rely on the outputs of this platform.

For instance, patent application U.S. 62/882,076 uses a 3-step approach consisting of: (1) a segmentation phase allowing the identification of the area of interest, (2) a categorization and evaluation of a set of anatomical or pathological measurements, and (3) a diagnosis. This approach is insufficient because it only relies on measurements and does not take into account the intricacies between several pathologies.

Furthermore, segmentation of the acquired MRI may be ill-done, thereby leading to an unreliable diagnosis output by such platform.

A purpose of the invention is to provide a device for determining at least one feature of a subject's spine, said device being more versatile and reliable than the aforementioned platform.

### SUMMARY

To this end, the present invention is a device of the aforementioned type, including a processing unit comprising:
at least one first module configured to receive a corresponding first set of spine image data associated to the subject, the first module being further configured to compute, based on spine image data representative of at least part of an examined spine, at least one first output relating to a first anatomical structure of the examined spine, the at least one first output including a first feature of the examined spine;
at least one second module, distinct from the first module, configured to receive:
   at least one first output of the first module; and
   a corresponding second set of spine image data associated to the subject,
the second module being further configured to compute, based on spine image data representative of at least part of the examined spine and the at least one first output of the first module, at least one second output relating to a second anatomical structure of the examined spine, the at least one second output including a second feature of the examined spine.

Indeed, regarding prediction of conditions, by using first outputs of the first module to compute second outputs (such as the second feature) of the second module, the invention allows to take into account the fact that knowledge relative to a given anatomical structure of the spine has consequences either on other anatomical structures, or on conditions of the same anatomical structure. This is due to the biomechanical correlation and compensation mechanisms across the length of the spine.

Furthermore, regarding processing of imaging signals, by using first outputs of the first module to compute second outputs (such as the second feature) of the second module, the invention allows to combine different acquisition sequences, for instance of a same anatomical structure of the spine, to achieve segmentation that is more reliable than the segmentation results that would be obtained without performing the approach according to the invention.

According to other advantageous aspects of the invention, the device includes one or more of the following features, taken alone or in any technically possible combination:
each first output received by the second module is representative of a relationship between the first feature computed by the first module and the second feature computed by the second module;
the first module is configured to implement a first artificial intelligence model to compute the first feature, and the second module is configured to implement a second artificial intelligence model to compute the second feature, the first artificial intelligence model and the second artificial intelligence model being configured to provide, during training, at least one weight of the first artificial intelligence model that is relevant for computation of the second feature by the second artificial intelligence model, the at least one first output received by the second module including each provided weight;
the first feature includes first condition data indicative of an occurrence of a predetermined first condition in the first anatomical structure, and the second feature includes second condition data indicative of an occurrence of a predetermined second condition in the second anatomical structure, the occurrence of the second condition being related to the occurrence of the first condition;
the second anatomical structure is the first anatomical structure, the occurrence of the second condition in the first anatomical structure being related to the occurrence of the first condition in the first anatomical structure;
at least part of the first spine image data and/or the second spine image data is representative of a geometry of the first anatomical structure and/or the second anatomical structure;
the first spine image data and/or the second spine image data comprise a corresponding label, a corresponding location, a location of at least one respective landmark, a corresponding boundary, a corresponding bounding box and/or a corresponding measurement;
the measurement includes a distance, an area, a volume and/or an angle within the first anatomical structure and/or the second anatomical structure, and/or a distance, an area, a volume and/or an angle between landmarks of the first anatomical structure and/or the second anatomical structure;
at least one of the first feature and the second feature is representative of a geometry of the first anatomical structure and/or the second anatomical structure;
at least one of the first feature and the second feature comprises a corresponding label, a corresponding location, a location of at least one respective landmark, a corresponding boundary, a corresponding bounding box and/or a corresponding measurement;
the measurement includes a distance, an area, a volume and/or an angle within the first anatomical structure and/or the second anatomical structure, and/or a distance, an area, a volume and/or an angle between landmarks of the first anatomical structure and/or the second anatomical structure;
the first set of spine image data includes first data acquired according to a first acquisition sequence, and the second set of spine image data includes second data acquired according to a second acquisition sequence distinct from the first acquisition sequence, the second anatomical structure being the first anatomical structure;
the first data and the second data include imaging signals representative of the first anatomical structure and/or the second anatomical structure;
the imaging signals comprise images.

The invention also relates to a system for detecting at least one condition in a subject's spine, the system comprising:
a first device as defined above, the first set of spine image data and the second set of spine image data including at least one imaging signal representative of the subject's spine, the first feature being representative of a geometry of the first anatomical structure of the subject's spine, and the second feature being representative of a geometry of the second anatomical structure of the subject's spine; and/or
a second device as defined above, the first set of spine image data and the second set of spine image data including at least one feature representative of a geometry of at least one of the first anatomical structure of the subject's spine and/or the second anatomical structure of the subject's spine, the first feature being representative of the occurrence of a first condition in the first anatomical structure, and the second feature being representative of a second condition in the second anatomical structure.

According to other advantageous aspects of the invention, the system includes one or more of the following features, taken alone or in any technically possible combination:
at least part of the first set of spine image data and the second set of spine image data received by the second device is an output of the first device;
the first condition and/or the second condition is a lumbar pathology;
the first condition and/or the second condition is a grade on a predetermined scale representative of at least one corresponding spine pathology, such as a lumbar pathology, preferably a grade on the Pfirrmann scale and/or a grade on the Modic type endplate changes scale;
the first set of spine image data and/or the second set of spine image data of the first device includes at least one of: an X-ray radiography imaging signal, a magnetic resonance imaging signal, and an ultrasound signal.

The invention also relates to a computer-implemented method for determining at least one feature of a subject's spine, the method comprising:
to at least one first artificial intelligence model, providing a first set of spine image data associated to the subject, the first artificial intelligence model being configured to compute, based on spine image data representative of at least part of an examined spine, at least one first output relating to a first anatomical structure of the examined spine, the at least one first output including a first feature of the examined spine;
to at least one second artificial intelligence model, distinct from the first artificial intelligence model, providing:
   at least one first output of at least one first artificial intelligence model; and
   a corresponding second set of spine image data associated to the subject,
the second artificial intelligence model being further configured to compute, based on spine image data representative of at least part of the examined spine and the at least one first output of the second artificial intelligence model, at least one second output relating to a second anatomical structure of the examined spine, the at least one second output including a second feature of the examined spine.

According to other advantageous aspects of the invention, the method includes one or more of the following features, taken alone or in any technically possible combination:
each first output received by the second artificial intelligence model is representative of a relationship between the first feature computed by the first artificial intelligence model and the second feature computed by the second artificial intelligence model;
the method includes a step of training the first artificial intelligence model and the second artificial intelligence model to provide at least one weight of the first artificial intelligence model that is relevant for computation of the second feature by the second artificial intelligence model, the at least one first output received by the second artificial intelligence model including each provided weight;
at least one of the first feature and the second feature is representative of a geometry of the first anatomical structure and/or the second anatomical structure;
at least one of the first feature and the second feature comprises a corresponding label, a corresponding location, a location of at least one respective landmark, a corresponding boundary, a corresponding bounding box and/or a corresponding measurement;
the measurement includes a distance, an area, a volume and/or an angle within the first anatomical structure and/or the second anatomical structure, and/or a distance, an area, a volume and/or an angle between landmarks of the first anatomical structure and/or the second anatomical structure;
the first set of spine image data includes first data acquired according to a first acquisition sequence, and the second set of spine image data includes second data acquired according to a second acquisition sequence distinct from the first acquisition sequence, the second anatomical structure being the first anatomical structure;
the first data and the second data include imaging signals representative of the first anatomical structure and/or the second anatomical structure;
the imaging signals comprise images.

According to further advantageous aspects of the invention, the method may also include one or more of the following features, taken alone or in any technically possible combination (and/or in combination with the aforementioned features):
the first feature includes first condition data indicative of an occurrence of a predetermined first condition in the first anatomical structure, and the second feature includes second condition data indicative of an occurrence of a predetermined second condition in the second anatomical structure, the occurrence of the second condition being related to the occurrence of the first condition;
the second anatomical structure is the first anatomical structure, the occurrence of the second condition in the first anatomical structure being related to the occurrence of the first condition in the first anatomical structure;
at least part of the first spine image data and/or the second spine image data is representative of a geometry of the first anatomical structure and/or the second anatomical structure;
the first spine image data and/or the second spine image data comprise a corresponding label, a corresponding location, a location of at least one respective landmark, a corresponding boundary, a corresponding bounding box and/or a corresponding measurement;
the measurement includes a distance, an area, a volume and/or an angle within the first anatomical structure and/or the second anatomical structure, and/or a distance, an area, a volume and/or an angle between landmarks of the first anatomical structure and/or the second anatomical structure.

### BRIEF DESCRIPTION OF THE DRAWINGS

The invention will be better understood with the attached figures, in which:

FIG. 1 is a schematic representation of a first embodiment of a spine condition detection system according to the invention;

FIG. 2 is an example illustrating operation of the spine condition detection system of FIG. 1;

FIG. 3 is a schematic representation of a second embodiment of a spine condition detection system according to the invention; and

FIG. 4 is a schematic representation of a third embodiment of a spine condition detection system according to the invention.

### DETAILED DESCRIPTION

According to the invention, the expression “anatomical structure” refers to a biological structure of the spinal region that is distinguished from neighboring structures. Anatomical structures may include vertebrae, ligaments, tendons, spinal cord, nerve roots, pedicle, neural foramina, intervertebral discs, facets, facet joints (or synovial joints), joint capsules, paraspinal muscles, spinal segments, lumbar spine, thoracic spine, cervical spine, or parts thereof.

According to the present invention, the expression “geometry of an anatomical structure” refers to a corresponding label, a corresponding location, a location of at least one respective landmark, a corresponding boundary, a corresponding bounding box and/or a corresponding measurement, wherein the measurement preferably includes a distance, an area, a volume and/or an angle within the anatomical structure, and/or a distance, an area, a volume and/or an angle between landmarks of the anatomical structure.

According to the present invention, the expression “imaging signal” refers to a signal output by a medical imaging device and that is representative of at least one imaged anatomical structure. The imaging signal may comprise a time-domain signal, a spectral-domain signal, and/or an image of said at least one imaged anatomical structure.

According to the invention, the expression “condition” refers to a state of the spine, involving one or several anatomical structure(s) of the spine, either adjacent or not. Said condition may be a pathology, and/or disease, and/or injury of the spine.

According to the invention, the expression “processing unit” refers to a processing device, regardless of its implementation, capable of executing instructions to perform associated and/or resulting functionalities.

According to the invention, the expression “spine image data” refers to data determined based on an imaging of at least part of a subject's spine. The spine image data may include imaging signals (as previously defined) and/or information computed based on said imaging signals.

### First Embodiment

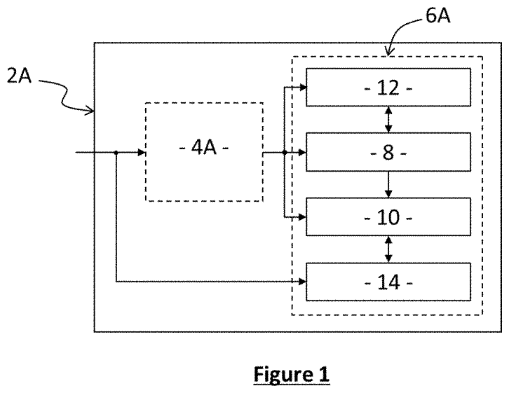

A system 2A according to a first embodiment of the invention is shown on FIG. 1. The system 2A is configured to provide diagnosis aid for diagnosing spinal conditions.

The system 2A includes an image processing device 4A and a prediction device 6A.

The image processing device 4A (also referred to as “image processing unit”) is configured to process at least one imaging signal associated to a subject, and more specifically one or several imaging signal(s) representative of at least part of the subject's spine, such as one or several image(s) of at least part of the subject's spine. The image processing device 4 is further configured to output spine image data associated to the subject and computed based on said at least one imaging signal.

Furthermore, the prediction device 6A (also referred to as “prediction unit”) is configured to compute, based on the spine image data output by the image processing device 4A, at least one feature of a subject's spine. For instance, at least one feature comprises condition data indicative of an occurrence of at least one predetermined condition relating to the subject's spine.

According to the present invention, each of the expressions “image processing unit” and “prediction unit” should not be construed to be restricted to hardware capable of executing software, and refers in a general way to a processing device, which can for example include a microprocessor, an integrated circuit, or a programmable logic device (PLD). Each of the image processing unit and the prediction unit may also encompass one or more Graphics Processing Units (GPU) or Tensor Processing Units (TSU), whether exploited for computer graphics and image processing or other functions. Furthermore, the expressions “image processing unit” and “prediction unit” should not be construed to be restricted to distinct processing devices. Additionally, the instructions and/or data enabling to perform associated and/or resulting functionalities may be stored on any processor-readable medium such as, e.g., an integrated circuit, a hard disk, a CD (Compact Disc), an optical disc such as a DVD (Digital Versatile Disc), a RAM (Random-Access Memory) or a ROM (Read-Only Memory). Instructions may be notably stored in hardware, software, firmware or in any combination thereof.

Image Processing Unit 4A

As stated previously, the image processing unit 4A is configured to process at least one input imaging signal associated to the subject in order to compute associated spine image data.

Each imaging signal is, for instance, an X-ray imaging signal, a magnetic resonance imaging (MRI) signal, or an ultrasound signal, such as an X-ray imaging image, a magnetic resonance imaging (MRI) image, or an ultrasound image.

In each of the three aforementioned imaging modalities, the imaging signal may be acquired while the subject is in a static position (static acquisition), or in several successive static positions, for example, flexion and then extension (also referred to as “dynamic acquisition”).

Furthermore, in each of the three aforementioned imaging modalities, the imaging signal may be acquired after injecting a contrast agent in the subject.

For instance, the X-ray imaging signal is acquired using at least one of the following techniques: Computed Tomography, Real Time Radiography, Dual-Energy X-Ray Absorptiometry (DEXA), and/or low-dose biplanar whole-body radiography in functional position (also referred to through its commercial name “EOS”).

For instance, the ultrasound imaging signal is acquired using standard echography and/or ultrasound elastography, the latter being well suited for determining mechanical properties of the imaged tissues.

For instance, the MRI imaging signal is acquired using standard MRI and/or magnetic resonance elastography, the latter being well suited for determining mechanical properties of the imaged tissues.

Preferably, the image processing unit 4A is configured to process imaging signals (more specifically 2D images) acquired according to different acquisition techniques. For instance, in the case of MRI imaging signal, the image processing unit 4A is configured to process imaging signals acquired according to different imaging sequences (T1w, T2w STIR, FLAIR, 3D, Dixon and so on) on at least one of the three anatomical planes (Sagittal, Axial, Coronal).

Hereinafter, said acquired imaging signals are also referred to as “input imaging signals”.

The image processing unit 4A is, for instance, configured to compute the image data by performing, on the input imaging signals, a pre-processing step, an anatomical structure segmentation step, a segmentation post-processing step, a centroid computation step and an intervertebral disc position computation step.

Pre-Processing

As mentioned above, the image processing unit 4A is preferably configured to apply, during the pre-processing step, at least one predetermined pre-processing transformation to each input imaging signal.

Furthermore, in the case where the input imaging signal is not an image, the image processing unit 4A is configured to compute, during the pre-processing step, an image based on the or each input imaging signal.

For instance, the image processing unit 4A is configured to apply, during the pre-processing step, at least one of: a resizing, an intensity transformation (such as an intensity normalization or an intensity clipping), an artefact correction (such as a bias field correction), and a pixel intensity distribution normalization (such as a histogram equalization or a registration method).

In the case of pixel intensity distribution normalization, the image processing unit 4A is, for instance, configured to modify a pixel intensity distribution of the input images to match a reference pixel intensity distribution. Such reference pixel intensity distribution is, preferably, a pixel intensity distribution of images used for training at least one artificial intelligence model implemented by the prediction device 6A, as will be disclosed later.

Anatomical Structure Segmentation

The image processing unit 4A is also configured to apply, during an anatomical structure segmentation step, a segmentation to each image (pre-processed image if the pre-processing step is performed, and input image if no pre-processing step is performed) in order to identify boundaries of predetermined anatomical structures.

Such anatomical structures include, for instance, vertebrae, intervertebral discs, paraspinal muscles, facet joints, nerves, cysts, osteophytes, edemas and/or blood vessels (artery and vena cava in particular).

For instance, the image processing unit 4A is configured to implement a 2D convolutional neural network (such as a neural network having a U-Net architecture) to perform such segmentation. In this case, during the anatomical structure segmentation step, each input image (or pre-processed image) is provided to the convolutional neural network, and, for each image, a set of raw 2D segmentation masks is obtained as an output. Each mask is associated to a corresponding anatomical structure (also referred to as “segmented anatomical structure”) appearing on the image.

An image associated to the corresponding segmentation masks (either raw or post-processed) is also referred to as “segmented image”.

Segmentation Post-Processing

The image processing unit 4A is also preferably configured to apply, during the post-processing step, at least one predetermined post-processing transformation to each set of raw 2D segmentation masks. Such step is intended, for example, to eliminate false positives and artefacts.

For instance, the image processing unit 4A is configured to perform, during the post-processing step, morpho-mathematical operations (such as erosion, dilatation, closing, opening, watershed transformation and the like) and connected components methods, either on the raw 2D segmentation masks, or on binarized versions thereof. This, for instance, allows to delete connected components of the raw 2D segmentation masks that are smaller than a predetermined threshold, or, in the case of masks corresponding to vertebrae, too far away from the rest of the vertebrae.

In the case of input images corresponding to successive slices of at least part of the subject's spine, the image processing unit 4A is further configured to compare, as a whole, the successive segmented images, for instance by implementing a voting algorithm. This allows to identify anatomical structures that appear in segmented images corresponding to successive slices and to delete noise and/or artefacts present in said segmented images.

Centroid Computation

Preferably, in the case where the image processing unit 4A is configured to determine vertebrae segmentation masks, the image processing unit 4A is also configured to compute a vertebra centroid for each segmented vertebra. In this case, for each vertebra, the image processing unit 4A is preferably configured to compute the vertebra centroid as the center of mass of said segmented vertebra, based on the corresponding segmentation masks. In other words, to compute the centroid of a given vertebra, the image processing unit 4A is configured to take into account the segmentation mask corresponding to said vertebra for each image representing the vertebra.

For instance, for a given vertebra, image processing unit 4A is configured to determine a plurality of partial centroids. More precisely, each partial centroid is the geometric center of a section of the vertebra on a respective 2D image representing said vertebra. In this case, the centroid of a given vertebra is the center of mass of all partial centroids corresponding to said vertebra.

The image processing unit 4A is further configured to assign each computed vertebra centroid to the corresponding vertebra.

The image processing unit 4A is advantageously configured to apply a similar processing for determining the centroid of other segmented anatomical structures of the spinal region.

Preferably, the vertebra centroid having the lowest position along a longitudinal axis of the spine is identified as the centroid of the sacrum S1. Alternatively, the centroid of S2 to S5 vertebras could also be identified.

Intervertebral Disc Position Computation

The image processing unit 4A may be configured to determine a position of intervertebral discs centroids. In this case, the image processing unit 4A is configured to determine, as an intervertebral disc centroid, a point on a spinal curve that is mid-distance between two successive vertebrae centroids.

More precisely, the image processing unit 4A is preferably configured to determine the aforementioned spinal curve. To do so, the image processing unit is advantageously configured to perform a polynomial regression, for instance using the vertebrae centroids as anchor points. The image processing 4A may further be configured to choose the polynomial degree as the number of anchor points.

Alternatively, instead of interpolating the intervertebral discs centroids from the segmented vertebrae, the image processing unit 4A is configured to directly perform segmentation on the intervertebral disc. In this case, the image processing unit 4A is configured to assign, for each intervertebral disc, the corresponding intervertebral disc centroid to the center of mass of said intervertebral disc.

The image processing unit 4A is preferably further configured to compute a bounding box around each intervertebral disc centroid, for instance by using the distance between the intervertebral disc and its neighboring vertebrae to compute height of the bounding box. More generally, for each identified anatomical structure, the corresponding bounding box can be regarded as a region of interest which includes said anatomical structure.

Preferably, the image processing unit 4A is further configured to perform, for each intervertebral centroid, a rotation of the corresponding bounding box using the normal to the spinal curve at the intervertebral centroid. As a result, the bounding boxes all have the same orientation from a segmented image to another, thereby allowing the system 2A to be invariant to relative rotations of the intervertebral discs from a segmented image to another. More generally, for bounding box, the image processing unit 4A may be configured to perform a similar rotation so that, for a given anatomical structure, the corresponding bounding boxes have a same orientation from a segmented image to the other.

Alternatively, the image processing unit is configured to perform object detection methods to directly determine bounding boxes and labels of vertebrae, intervertebral discs and other identified anatomical structures. For instance, in order to determine bounding boxes around the intervertebral discs, the image processing unit 4A is configured to implement a mask region-based convolutional neural network (R-CNN).

The spine image data output by the image processing unit 4A and received by the prediction unit 6A include, for each anatomical structure, the corresponding determined location (or location of respective landmarks), corresponding boundaries (i.e., outer limits), corresponding bounding box(es), associated measurements (such as distances, areas, volumes and angles within the anatomical structures and between landmarks thereof) and/or corresponding label(s). Preferably, the spine image data preferably also include each image and the corresponding segmentations masks.

For instance, in the case of vertebrae and intervertebral discs, the spine image data computed by the image processing unit 4A include the location of the centroid of each vertebra, the label of each vertebra, the location of the centroid of each intervertebral disc, associated measurements (such as width, height, orientation, etc.) and/or the label of each intervertebral disc, as well as each acquired imaging signal (e.g., each acquired image), associated to the corresponding segmentation masks.

Prediction Unit 6A

As previously stated, the prediction unit 6A is configured to compute, based on the spine image data provided by the image processing unit 4A, at least one feature of a subject's spine. Each feature includes, for instance, condition data indicative of an occurrence of at least one predetermined condition relating to the subject's spine.

The prediction unit 6A comprises at least a first module 8 (also referred to as “first prediction module”), and a second module 10 (also referred to as “second prediction module”). In the example of FIG. 1, the prediction unit 6A further includes additional modules 12 (also referred to as “third prediction module”) and 14 (also referred to as “fourth prediction module”).

First Prediction Module 8

The first prediction module 8 is configured to receive a first set of spine image data associated to the subject, among the spine image data output by the image processing unit 4A.

The first prediction module 8 is also configured to compute, based on spine image data representative of at least part of an examined spine, at least one first output relating to a first anatomical structure of the examined spine. Consequently, the first prediction module 8 is configured to compute at least one first output relating to the first anatomical structure of the current patient's spine based on the first set of spine image data. In this case, the at least one first output includes a first feature of the examined spine.

For instance, to compute each first output, the first prediction module 8 is configured to implement an artificial intelligence model.

Furthermore, according to the present invention, by “first output of the first module”, it is meant any data or parameter (such as a weight) that is a result of a calculation performed by said first prediction module 8. Such data may be, for example, a grade (number), a landmark (vector), or an area (matrix), a segmentation result, a position, a probability, etc. Furthermore, each parameter may be a weight of the artificial intelligence model, determined either during or after training of said model.

The first feature preferably comprises first condition data (comprised in the aforementioned condition data) indicative of an occurrence of a predetermined first condition in the first anatomical structure.

The first condition (as well as the second condition described hereinafter) is, for instance, one of: Modic type endplate changes, Schmorl node, anterolisthesis, retrolisthesis, laterolisthesis, disc degeneration, hypolordosis, hyperlordosis, scoliosis, disc herniation (symmetric bulging, asymmetric bulging protrusion and extrusion) and its location, sequestration status, nerve root compression status, spinal canal stenosis and its origins, lateral recess stenosis and its origins, neural foraminal stenosis and its origins, compression fracture and its acute status, paraspinal muscle atrophy, fatty involution in paraspinal muscle, facet arthropathy and its origins, tumors, infection, and so on.

Second Prediction Module 10

The second prediction module 10 is configured to receive a second set of spine image data associated to the subject, among the spine image data output by the image processing unit 4A. The second set of spine image data may be identical to or different from the first set of spine image data.

The second prediction module 10 is also configured to receive at least one first output of the first prediction module 8. This is illustrated, on FIG. 1, by an arrow going from the first prediction module 8 to the second prediction module 10.

The second prediction module 10 is further configured to compute, based on spine image data representative of at least part of the examined spine and at least one first output of the first module, at least one second output relating to a second anatomical structure of the examined spine. Consequently, the second prediction module 10 is configured to compute at least one second output relating to the second anatomical structure of the current patient's spine based on the at least one first output and the second set of spine image data. In this case, the at least one second output includes a second feature of the examined spine.

Preferably, the second feature includes second condition data indicative of an occurrence of a predetermined second condition in the second anatomical structure. More precisely, the occurrence of the second condition is related to the occurrence of the first condition. In this case, the second anatomical structure is preferably the first anatomical structure, or a second anatomical structure of the spine, distinct (i.e., different) from the first anatomical structure, for instance an anatomical structure adjacent to the first anatomical structure, or located at a distance from the first anatomical structure.

For instance, to compute each second output, the second prediction module 10 is configured to implement an artificial intelligence model.

As mentioned above, each first output of the first prediction module 8 that is input to the second prediction module 10 may be data or a parameter (such as a weight) computed by said first prediction module 8. Determination of said data may be determined after or during training of the first and second prediction modules 8, 10.

For instance, the second prediction module 10 is configured to compute each second output using at least part of the weights of the model implemented by the first prediction module 8.

Each first output of the first prediction module 8 that is input to the second prediction module 10 may be chosen using a qualitative or a quantitative approach, or a combination of both approaches.

For instance, each first output that is input to the second prediction module 10 may be quantitatively chosen by implementing, during configuration (i.e., training) of the first and second prediction modules 8, 10, an algorithm (such as attention mechanism, gradient descent, and the like) adapted to highlight weight patterns of the model of the first prediction module 8 that are relevant for the model of the second prediction module 10.

As a first example, a first prediction module 8 configured to predict the occurrence of Schmorl nodes and a second prediction module 10 configured to predict the occurrence of Modic type endplate changes are considered. Additionally, a model is trained to determine co-attention coefficients between layer i of the first module 8 and layer j of the second module 10. These co-attention coefficients are representative of which part of the high-level features of layer i of the first prediction module 8 are input to the layer j of the second prediction module 10. This configuration is advantageous because Schmorl nodes and Modic type endplate degeneration share similar indicators like the localization of endplate and hypersignal in T2w imaging Thus, mid and high-level features can easily be shared through co-attention connections between the Schmorl node prediction module (i.e., the first prediction module 8) and the Modic type endplate changes prediction module (i.e., the second prediction module 10).

Alternatively, each first output that is input to the second prediction module 10 may be qualitatively determined using prior knowledge regarding a relationship between the first feature computed by the first prediction module 8 and the second feature computed by the second prediction module 10.

For instance, in the case where the second condition is disc degeneration, the second prediction module 10 is advantageously configured to receive outputs from a first prediction module 8 configured to compute first condition data indicative of an occurrence of Modic type endplate changes.

In the case where the artificial intelligence model implemented by the first prediction module 8 is a neural network, the choice of each first output that is provided to the second prediction module 10 may relate to a choice of weights at specified depth levels of the neural network. In this case, the weights computed by the first layers of the neural network correspond to information of low complexity, and are referred to as “low level” outputs. Moreover, the weights computed by the last layers of the neural network correspond to information of high complexity, and are referred to as “high level” outputs.

In another example, the second prediction module 10 is configured to take as input, in addition to the second set of spine image data, one or more first feature(s) computed by the first prediction module 8. For example, this configuration is advantageous in the case where the first prediction module 8 is configured to predict the existence of a herniated disc, while the second prediction module 10 is configured to predict the existence of a spinal canal stenosis. Indeed, the presence of a herniated disc is one of the possible origins of spinal canal stenosis. Therefore, the knowledge that there exists a herniated disc is likely to cause the second prediction module 10 to be more reliable.

As another example, the first prediction module 8 is configured to compute first features that include information relating to the occurrence of a given condition, as well as a hint for this condition. In this case, the second prediction module 10 is configured to take as input, in addition to the second set of spine image data, each hint computed by the first prediction module 8. For example, this configuration is advantageous in the case where the second prediction module 10 is configured to predict the existence of a spinal canal stenosis, and the first prediction module 8 is configured to predict the existence of a herniated disc as well as, as a corresponding hint, the localization of the disc and the spinal canal. Since such hint is strongly correlated to the condition that the second prediction module 10 is configured to predict, the reliability of such prediction is highly increased.

As another example, the first prediction module 8 and the second prediction module 10 are associated to anatomical structures that are located at different levels along a direction of the spine, for instance anatomical structures that are located along the direction of the spine, such as adjacent along the direction of the spine. For example, the first prediction module 8 is configured to predict the existence of a spondylolisthesis at a first vertebral level, and the second prediction module 10 is configured to determine the existence of a herniated disc at another vertebral level. This is advantageous, because the spine is a structure along which anatomical structures are mechanically coupled. As a result, a biomechanical property on a given vertebral level (such as spondylolisthesis) is likely to have biomechanical consequences on the neighboring levels. As a result, the reliability of the second prediction module 10 is increased.

Even though the example of FIG. 1 shows one first prediction module 8, and one second prediction module 10, there can be several first prediction modules, and/or several second prediction modules. In this case, at least one pair including a first prediction module and second prediction module as described above is defined. Moreover, a first prediction module may be configured to feed data to several second prediction modules.

Third Prediction Module 12

As shown on FIG. 1, a double-headed arrow connects the third prediction module 12 and the first prediction module 8. This means that:
on the one hand, the third prediction module 12 is configured to operate as a second prediction module, thereby computing a spine feature (distinct from that computed by the second prediction module 10), based on at least one output of the first prediction module 8 and a third set of image data of the set of image data;
on the other hand, the module 8 is configured to operate as a second prediction module described above, receiving, as inputs, outputs of the third prediction module 12.

Even though the third prediction module 12 is configured to operate as a second prediction module, the third set of image data, the output received from the first prediction module and/or the computed feature differ from those corresponding to the second prediction module 10 described above.

Alternatively, the second prediction module is not provided. In this case, module 8 acts as a first prediction module with respect to module 12, and vice versa.

Fourth Prediction Module 14

As shown on FIG. 1, the fourth prediction module is configured to compute at least one feature relating to the subject's spine based on at least one acquired imaging signal, without prior image processing. In this case, the corresponding set of image data is the at least one acquired imaging signal.

The fourth prediction module 14 may provide outputs to and/or receive outputs from any of prediction modules 8, 10, 12. For instance, on the example of FIG. 1, the fourth prediction module 14 is configured to provide outputs to and receive outputs from the second prediction module 10.

Operation

During a configuration step, the first and second prediction modules 8, 10 of the prediction device 6A are configured, and each first output that is shared from the first prediction module 8 to the second prediction module 10 is selected.

In the case where the first and second prediction modules 8, 10 implement artificial intelligence models, said models are trained during the configuration step, either separately or jointly.

Then, during an acquisition step, imaging signals representative of at least part of the spinal region of a subject are acquired.

Then, the image processing device 4A computes the spine image data based on the acquired imaging signals.

Then, during a prediction step, the first prediction module 8 receives a first set of spine image data, and computes at least one corresponding first output. Said at least one first output includes a first feature of the examined spine.

Moreover, during the prediction step, the second prediction module 10 receives at least one first output of the first prediction module 8, and a second set of spine image data, and computes, based thereon, at least one second output. Said at least one second output includes a second feature of the examined spine.

For instance, the first feature and the second feature are displayed to a healthcare provider, on a display or the like.

### Example

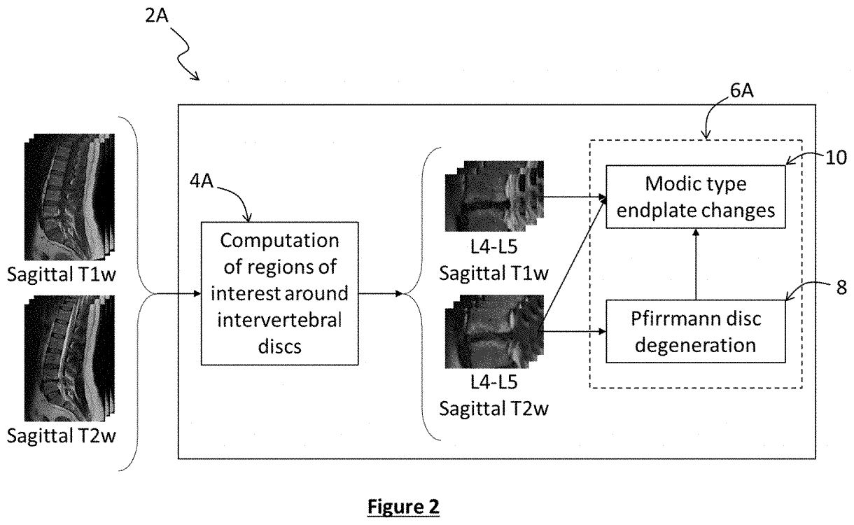

An exemplary implementation of the system 2A is shown on FIG. 2.

In this case, the imaging signals include sagittal sequences T1w and T2w of the lumbar spine of a subject.

These imaging signals are fed to the image processing device 4A. Based on these imaging signals, the image processing device 4A performs pre-processing, segmentation and post-processing steps, and computes regions of interest around the intervertebral discs of the spine, which are provided as an output. For the sake of clarity, only one region of interest around the L4-L5 intervertebral disc is shown on FIG. 2, according to the two original imaging modalities T1 w and T2w. These outputs form spine image data.

These regions of interest are provided as inputs to a first modules 8 and a second module 10 which are configured to perform, respectively, diagnosis of disc degeneration and endplate degeneration.

In the case of disc degeneration, the first condition data preferably also comprises a grade on the Pfirrmann scale. Furthermore, in the case of endplate degeneration, the first condition data preferably also includes a grade on the Modic type endplate changes scale. The same applies to the second condition data mentioned below.

Modules 8 and 10 do not have the same inputs. More precisely, the first set of spine image data input to the first module 8 only includes the regions of interest according to the sagittal T2w imaging modality. On the other hand, the second set of spine data input to the second module 10 includes the regions of interest according to sagittal T2w and T1w imaging modalities. Furthermore, the second set of spine data also includes the diagnosis of Pfirrmann disc degeneration performed by the first module 8. This unilateral sharing of information from module 8 to module 10 has been implemented because, from a clinical point of view, the grade on the Pfirrmann scale is an explanatory factor of the grade on the Modic scale.

### Second Embodiment

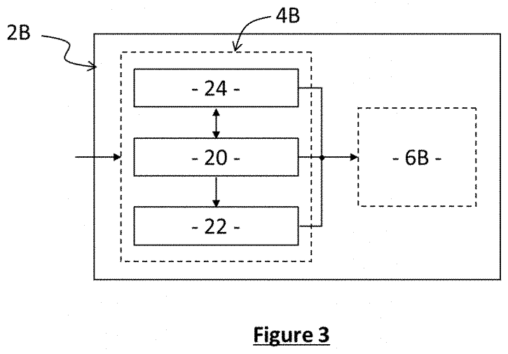

A system 2B according to a second embodiment of the invention is shown on FIG. 3. Similarly to the system 2A, the system 2B is also configured to provide diagnosis aid of spinal conditions.

The system 2B includes an image processing device 4B, and a prediction device 6B.

Image Processing Unit 4B

The second embodiment differs from the first embodiment in that the image processing unit 4B includes at least a first module 20 (also referred to as “first image processing module”) and a second module 22 (also referred to as “second image processing module”). In the example of FIG. 3, the image processing unit 4B further includes an additional module 24 (also referred to as “third image processing module”).

First Image Processing Module 20

The first image processing module 20 is configured to receive a first set of spine image data associated to the subject. In this case, the first set of spine image data corresponds to a set of acquired imaging signals (e.g., images) that are representative of the subject's spine.

Furthermore, the first image processing module 20 is configured to compute, based on spine image data representative of at least part of an examined spine, at least one first output relating to a first anatomical structure of the examined spine. Consequently, the first image processing module 20 is configured to compute at least one first output relating to the first anatomical structure of the current patient's spine based on the first set of spine image data, i.e., the first set of acquired spine imaging signals.

In this case, the at least one first output includes a first feature of the examined spine.

For instance, to compute each first output, the first image processing module 20 is configured to implement an artificial intelligence model.

Furthermore, as stated in relation to the system 2A, a first output may be any data or parameter (such as a weight) that is a result of a calculation performed by said first image processing module 20. Such data may be, for example, a grade (number), a landmark (vector), or an area (matrix), a segmentation result, a position, a probability, etc. Furthermore, each weight may be a weight of the artificial intelligence model, determined either during or after training of said model.

Second Image Processing Module 22

The second image processing module 22 is configured to receive a second set of spine image data associated to the subject. In this case, the second set of spine image data corresponds to a set of acquired imaging signals (e.g., images) that are representative of the subject's spine. The second set of spine image data may be identical to or different from the first set of spine image data.

The second image processing module 22 is also configured to receive at least one first output of the first image processing module 20. This is illustrated, on FIG. 3, by an arrow going from the first image processing module 20 to the second image processing module 22.

Furthermore, the second image processing module 22 is configured to compute, based on spine image data representative of at least part of the examined spine and at least one first output of the first image processing module 20, at least one second output relating to a second anatomical structure of the examined spine. Consequently, the second image processing module 22 is configured to compute at least one second output relating to the second anatomical structure of the current patient's spine based on the at least one first output and the second set of spine image data, i.e., the second set of acquired imaging signals. In this case, the at least one second output includes a second feature of the examined spine.

For instance, to compute each second output, the second image processing module 22 is configured to implement an artificial intelligence model.

Preferably, each of the first feature and the second feature is representative of a geometry of the corresponding anatomical structure. More precisely, the first feature representative of a geometry of a first anatomical structure is related to the second feature representative of a geometry of the second anatomical structure. In this case, the second anatomical structure is preferably the first anatomical structure, or a second anatomical structure of the spine, distinct from the first anatomical structure, for instance an anatomical structure adjacent to the first anatomical structure, or located at a distance from the first anatomical structure.

For instance, for each anatomical structure, the corresponding first feature and/or second feature includes at least one of: corresponding location (or location of respective landmarks), corresponding boundaries (i.e., outer limits), corresponding bounding box(es), associated measurements (such as distances, areas, volumes and angles within the anatomical structures and between landmarks thereof) and/or corresponding label(s).

Advantageously, the first set of spine image data includes at least one imaging signal acquired according to a first acquisition sequence, and the second set of spine image data includes at least one imaging signal acquired according to a second acquisition sequence distinct from the first acquisition sequence. This allows to take into account more information than in the case where only one acquisition sequence is considered, thereby leading to more accurate feature computation. This is especially the case when the second anatomical structure is the first anatomical structure.

In a similar fashion to the configuration of the first and second prediction modules of system 2A, each first output of the first image processing module 20 that is input to the second image processing module 22 may be data or a weight computed by said first image processing module 20.

Furthermore, as discussed previously in relation to the system 2A, each first output of the first image processing module 20 that is input to the second image processing module 22 may be chosen using a qualitative or a quantitative approach, or a combination of both approaches.

As an example, the first image processing module 20 comprises a first stage configured to extract low level features from an acquired imaging signal, and a second stage including a first neural network configured to perform intervertebral disc localization and/or identification. Furthermore, the second image processing module 22 comprises a second neural network configured to perform intervertebral disc segmentation. In this example, the first and second image processing modules 20, 22 are configured so that they share information by having co-attention coefficients between associated layers in the first and second neural networks. These coefficients are learned during training and allow to control how much high-level features from a layer i of the first neural network has to be shared to a layer j of the second module. This is advantageous, especially for segmentation. Indeed, having information regarding the nature of an anatomical structure (for instance: “the detected vertebra is S1”) provides context to the second neural network regarding which vertebrae is being segmenting, thereby allowing the second neural network to perform a more accurate segmentation.

As another example, the first image processing module 20 and the second image processing module 22 are configured to respectively implement a segmentation neural network and a bounding box identification model (also called “region proposal model”). In this case, the region proposal model is configured to perform bounding box identification based on acquired images representing the spine of a subject, as well as high-level features output by the segmentation model. This feature is advantageous, as it speeds up computation and improves the quality of the bounding boxes proposed by the region proposal model.

Even though the example of FIG. 3 shows one first image processing module 20, and one second image processing module 22, there can be several first image processing modules, and/or several second image processing modules. In this case, at least one pair including a first image processing module and second image processing module as described above is defined. Moreover, a first image processing module may be configured to feed data to several second image processing modules.

Third Image Processing Module 24

As shown on FIG. 1, a double-headed arrow connects the third image processing module 24 and the first image processing module 20. This means that:
on the one hand, the third image processing module 24 is configured to operate as the second image processing module 20, thereby computing a spine feature based at least one output of the first image processing module 20;
on the other hand, the module 20 is configured to operate as a second image processing module described above, receiving, as inputs, outputs of the third image processing module 24.

Alternatively, the second image processing module is not provided. In this case, module 20 acts as a first prediction module with respect to module 24, and vice versa.

Prediction Unit 6B

The prediction unit 6B is configured to compute, based at least on the first feature and the second feature computed by the image processing unit 4B, condition data indicative of an occurrence of at least one predetermined condition relating to the subject's spine.

The prediction unit 6B is, for instance, configured to implement a known processing pipeline to determine the aforementioned condition data.

Operation

During a configuration step, the first and second image processing modules 20, 22 of the image processing device 4B are configured, and each first output that is shared from the first image processing module 20 to the second image processing module 20 is selected.

In the case where the first and second image processing modules 20, 22 implement artificial intelligence models, said models are trained during the configuration step, either separately or jointly.

Then, during an acquisition step, imaging signals representative of at least part of the spinal region of a subject are acquired. Said acquired imaging signals form a set of spine image data.

Then, during an image processing step, the first image processing module 20 receives a first set of spine image data of the set of spine image data, and computes at least one corresponding first output. Said at least one first output includes a first feature of the examined spine.

Moreover, during the image processing step, the second image processing module 22 receives at least one first output of the first image processing module 20, and a second set of spine image data of the set of spine image data, and computes, based thereon, at least one second output. Said at least one second output includes a second feature of the examined spine.

Then, during a prediction step, the prediction device 6B computes condition data indicative of an occurrence of at least one predetermined condition relating to the subject's spine based at least one the first and second features computed by the image processing device 4B.

### Third Embodiment

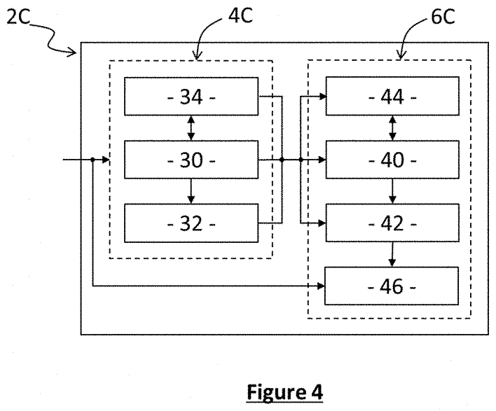

A system 2C according to a third embodiment of the invention is shown on FIG. 4. Similarly to the systems 2A and 2B, the system 2C is also configured to provide diagnosis aid of spinal conditions.

The system 2C includes an image processing device 4C, and a prediction device 6C.

The image processing device 4C is configured similarly to the image processing device 4B of the system 2B, and includes at least a first module 30 and a second module 32, and preferably a third module 34. More precisely, modules 30, 32 and 34 are similar to modules 20, 22 and 24 respectively of the image processing device 4B of the system 2B.

In this case, the spine image data processed by the image processing device 4C include the acquired imaging signals representative of at least part of the subject's spine.

Furthermore, the prediction device 6C is configured similarly to the prediction device 6B of the system 2B, and includes at least a first module 40 and a second module 42, and preferably a third module 44 and/or a fourth module 46. More precisely, modules 40, 42, 44 and 46 are similar to modules 8, 10, 12 and 14 respectively of the prediction device 6B of the system 2B.

In this case, the spine image data processed by the prediction device 6C include at least first and second features computed by the modules 30, 32 and 34 and, preferably, relating to a geometry of at least one anatomical structure of the subject's spine.

1. A device for determining at least one feature of a subject's spine, the device including a processing unit comprising:
at least one first module configured to receive a corresponding first set of spine image data associated to the subject, the first module being further configured to compute, based on spine image data representative of at least part of an examined spine, at least one first output relating to a first anatomical structure of the examined spine, the at least one first output including a first feature of the examined spine;
at least one second module, distinct from the first module, configured to receive:
at least one first output of the first module; and
a corresponding second set of spine image data associated to the subject,
the second module being further configured to compute, based on spine image data representative of at least part of the examined spine and the at least one first output of the first module, at least one second output relating to a second anatomical structure of the examined spine, the at least one second output including a second feature of the examined spine.

2. The device according to claim 1, wherein each first output received by the second module is representative of a relationship between the first feature computed by the first module and the second feature computed by the second module.

3. The device according to claim 2, wherein the first module is configured to implement a first artificial intelligence model to compute the first feature, and the second module is configured to implement a second artificial intelligence model to compute the second feature,
the first artificial intelligence model and the second artificial intelligence model being configured to provide, during training, at least one weight of the first artificial intelligence model that is relevant for computation of the second feature by the second artificial intelligence model, the at least one first output received by the second module including each provided weight.

4. The device according to claim 1, wherein the first feature includes first condition data indicative of an occurrence of a predetermined first condition in the first anatomical structure, and the second feature includes second condition data indicative of an occurrence of a predetermined second condition in the second anatomical structure, the occurrence of the second condition being related to the occurrence of the first condition.

5. The device according to claim 4, wherein the second anatomical structure is the first anatomical structure, the occurrence of the second condition in the first anatomical structure being related to the occurrence of the first condition in the first anatomical structure.

6. The device according to claim 4, wherein at least part of the first spine image data and/or the second spine image data is representative of a geometry of the first anatomical structure and/or the second anatomical structure,
and, preferably, the first spine image data and/or the second spine image data comprise a corresponding label, a corresponding location, a location of at least one respective landmark, a corresponding boundary, a corresponding bounding box and/or a corresponding measurement,
wherein the measurement preferably includes a distance, an area, a volume and/or an angle within the first anatomical structure and/or the second anatomical structure, and/or a distance, an area, a volume and/or an angle between landmarks of the first anatomical structure and/or the second anatomical structure.

7. The device according to claim 1, wherein at least one of the first feature and the second feature is representative of a geometry of the first anatomical structure and/or the second anatomical structure,
and preferably comprises a corresponding label, a corresponding location, a location of at least one respective landmark, a corresponding boundary, a corresponding bounding box and/or a corresponding measurement, wherein the measurement preferably includes a distance, an area, a volume and/or an angle within the first anatomical structure and/or the second anatomical structure, and/or a distance, an area, a volume and/or an angle between landmarks of the first anatomical structure and/or the second anatomical structure.

8. The device according to claim 7, wherein the first set of spine image data includes first data acquired according to a first acquisition sequence, and the second set of spine image data includes second data acquired according to a second acquisition sequence distinct from the first acquisition sequence, the second anatomical structure being the first anatomical structure.

9. The device according to claim 7, wherein the first data and the second data include imaging signals representative of the first anatomical structure and/or the second anatomical structure, the imaging signals preferably comprising images.

10. A system for detecting at least one condition in a subject's spine, the system comprising:
a first device and/or a second device, each according to claim 1;
wherein for the first device, the first set of spine image data and the second set of spine image data including at least one imaging signal representative of the subject's spine, the first feature being representative of a geometry of the first anatomical structure of the subject's spine, and the second feature being representative of a geometry of the second anatomical structure of the subject's spine; and
wherein for the second device, the first set of spine image data and the second set of spine image data including at least one feature representative of a geometry of at least one of the first anatomical structure of the subject's spine and/or the second anatomical structure of the subject's spine, the first feature being representative of the occurrence of a first condition in the first anatomical structure, and the second feature being representative of a second condition in the second anatomical structure.

11. The system according to claim 10, wherein the first condition and/or the second condition is a lumbar pathology.

12. The system according to claim 10, wherein the first set of spine image data and/or the second set of spine image data of the first device includes at least one of: an X-ray radiography imaging signal, a magnetic resonance imaging signal, and an ultrasound signal.

13. A computer-implemented method for determining at least one feature of a subject's spine, the method comprising:
to at least one first artificial intelligence model, providing a first set of spine image data associated to the subject, the first artificial intelligence model being configured to compute, based on spine image data representative of at least part of an examined spine, at least one first output relating to a first anatomical structure of the examined spine, the at least one first output including a first feature of the examined spine;
to at least one second artificial intelligence model, distinct from the first artificial intelligence model, providing:
at least one first output of at least one first artificial intelligence model; and
a corresponding second set of spine image data associated to the subject,
the second artificial intelligence model being further configured to compute, based on spine image data representative of at least part of the examined spine and the at least one first output of the second artificial intelligence model, at least one second output relating to a second anatomical structure of the examined spine, the at least one second output including a second feature of the examined spine.

14. The method according to claim 13, wherein at least one of the first feature and the second feature is representative of a geometry of the first anatomical structure and/or the second anatomical structure,
and preferably comprises a corresponding label, a corresponding location, a location of at least one respective landmark, a corresponding boundary, a corresponding bounding box and/or a corresponding measurement, wherein the measurement preferably includes a distance, an area, a volume and/or an angle within the first anatomical structure and/or the second anatomical structure, and/or a distance, an area, a volume and/or an angle between landmarks of the first anatomical structure and/or the second anatomical structure.

15. The method according to claim 13, wherein the first set of spine image data includes first data acquired according to a first acquisition sequence, and the second set of spine image data includes second data acquired according to a second acquisition sequence distinct from the first acquisition sequence, the second anatomical structure being the first anatomical structure.
